(19) United States
(12) Patent Application Publication
(10) Pub. No.: US 2015/0065924 A1
(43) Pub. Date: Mar. 5, 2015

(54) SPORT ROLLER WITH TEMPERATURE ELEMENT

(71) Applicant: Jean HELLER, San Leandro, CA (US)

(72) Inventor: Jean HELLER, San Leandro, CA (US)

(21) Appl. No.: 14/173,567

(22) Filed: Feb. 5, 2014

Related U.S. Application Data
(60) Provisional application No. 61/874,247, filed on Sep. 5, 2013.

(51) Int. Cl. A61H 15/02

(52) U.S. Cl. CPC A61H 15/02
USPC 601/18

(57) ABSTRACT

A device including a fabric substrate with a plurality of enclosures and a plurality of gel-based thermally conductive compounds, said compounds enclosed in a flexible, thermally-permeable material and disposed in each enclosure. The device also includes a substantially tubular foam member wherein the fabric substrate is a single material formed as a bag for enclosing the foam member, said bag having an opening at a first end, said opening including a closure such as a draw-string or tie. In some embodiments the enclosures are pockets and the thermally conductive compounds are removable. A user may heat or cool the thermally conductive compounds, insert them into the enclosures around the foam member and enjoy the benefit of a heated or cooled therapeutic exercise roller.

### PRIORITY

This application claims the benefit of co-pending U.S. provisional patent application 61/874,247 by the same inventor filed on Sep. 5, 2013 which is incorporated by reference as if fully set forth herein.

### BACKGROUND

Foam rollers may be helpful for alleviating muscle tightness and tension; however they may be therapeutically limited without thermal capability. Moreover, foam rollers are often dull and industrial looking and not consistent with an active/fitness aesthetic look. Conventionally, to achieve the heating or cooling effect while using a foam roller would require a person to lay a bulky heating pad on top of the foam roller, and then balance on top of it. Rolling the heated portion through or near the muscle would not be possible because the pad would fall off as the roller turns. Additionally, the bulkiness of the pad would at best be uncomfortable, and possibly prohibit the benefit of the direct pressure from the roller applied to the targeted muscle. For older people and those with balance issues, it could be injurious if their movement on the roller causes the pad, and themselves, to slide off the roller.

### SUMMARY

Disclosed herein are multiple embodiments including a device having a fabric substrate with a plurality of enclosures and a plurality of gel-based thermally conductive compounds, said compounds enclosed in a flexible, thermally-permeable material and disposed in each enclosure. A substantially tubular foam member wherein the fabric substrate is a single material formed as a bag for enclosing the foam member, said bag having an opening at a first end, said opening including a draw-string closure. In some embodiments the enclosures are pockets and the thermally conductive compounds are removable. A user may heat or cool the thermally conductive compounds, insert them into the enclosures around the foam member and enjoy the benefit of a heated or cooled therapeutic exercise roller.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates an embodiment of a structure which may be employed in a sport roller with temperature element according to the current disclosure.

FIG. 2 illustrates an embodiment according to the current disclosure.

FIG. 3 shows an alternative embodiment according to the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

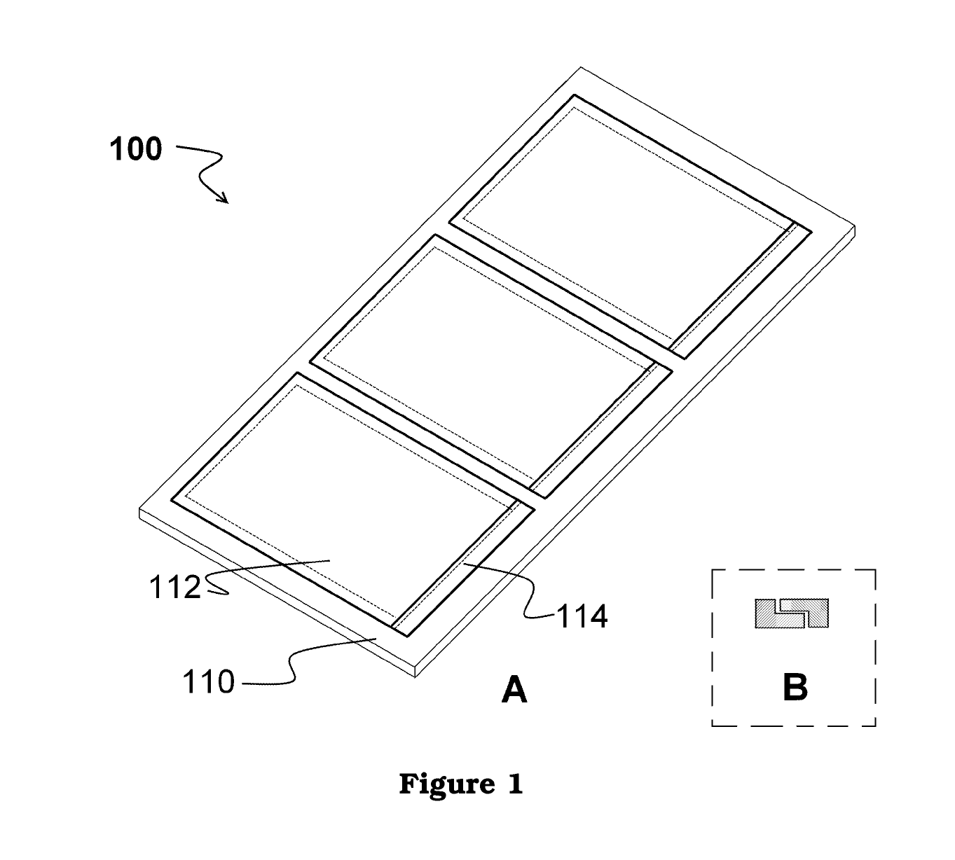

FIG. 1 illustrates an embodiment of a structure which may be employed in a sport roller with temperature element according to the current disclosure. In FIG. 1A a thermally permeable substrate 110, which may be made from fabric, plastic and the like, includes an enclosure 112 such as a pocket. The enclosure 112 is also comprised of thermally permeable material and is disposed on a first side of the fabric 110 and may be held in place using conventional fasteners such as stitching, gluing and the like. The enclosure 112 is disposed for receiving a thermally conductive material such as gels, clay, corn and the like. The thermally conductive material will generally be enclosed in a flexible thermally permeable material to allow for control of the material when separated from the substrate 110.

In FIG. 1A the fabric 110 is sewn together with the thread and the thermally conductive material is inserted into an enclosure 112. The enclosure may have fasteners 114 such as zippers, buttons, VELCRO and the like. The fasteners may be sewn to the fabric 110 and act to secure the thermally conductive material into the enclosure.

### Thermally Conductive Material

Certain embodiments described herein may include thermally conductive material such as gels, earth (or clay) and natural elements such as corn or other grains. In one embodiment a pliable, self-sustaining, moisture sorbing gel including a humectant such as glycerin entrapped within a synthetic resin polymer matrix (e.g., a matrix containing acrylic acid or acrylamide monomer moieties) may be employed. In this embodiment, a body of the gel is encased within heat and moisture-permeable stretch fabric. In use, gel may be either heated (as in a microwave oven) or refrigerated, so as to provide appropriate thermal treatment. Conventionally available gels, such as those from Southwest Technologies Inc. may retain their pliability and other physical properties over a very broad temperature range allowing such gels to be used in many treatment contexts.

Although multiple portions of the thermally conductive material is shown in FIG. 1A as being placed abutting each other, in certain embodiments the thermally conductive material may be disposed to overlap one edge for another edge as shown in FIG. 1B. This overlapping rabbet edge has the effect of providing complete (or near complete) coverage of portions of the substrate 110 with thermally conductive material. One having skill in the art will recognize that to effect the embodiment shown in FIG. 1B will require constructing the pockets in such a way as to let the thermally conductive material rest in an overlapping position and to make the edges of the thermally conductive material rabbetted in a way to allow overlapping.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

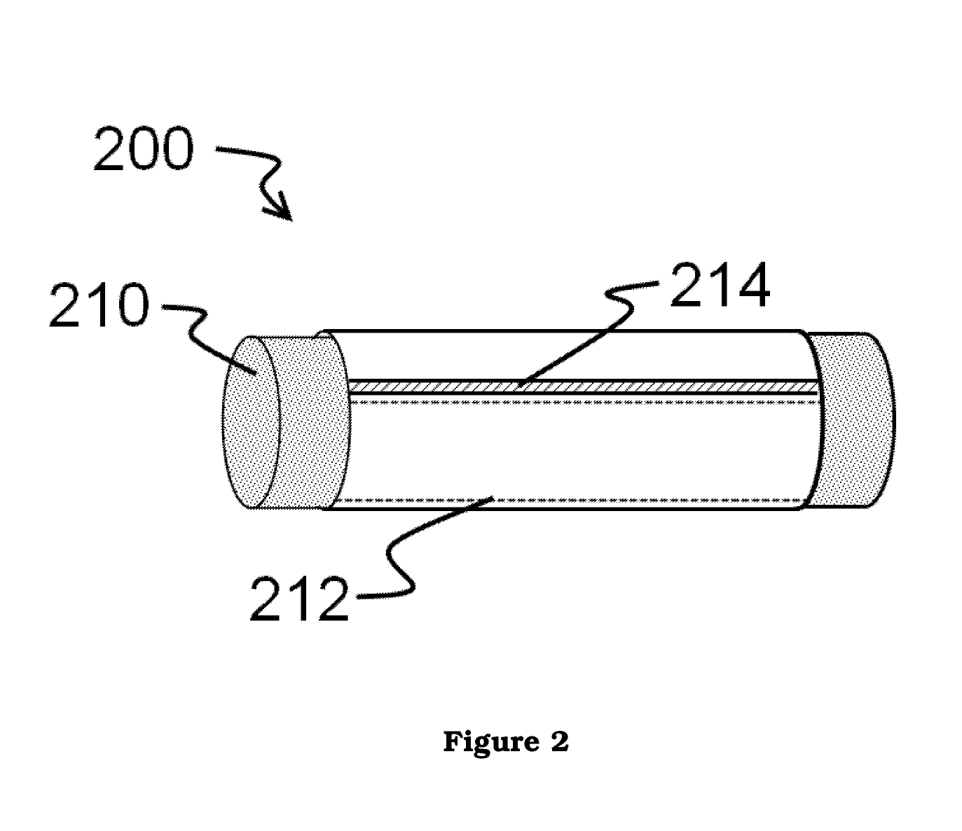

FIG. 2 illustrates an embodiment 200 according to the current disclosure. In FIG. 2 a pocketed substrate 212 having thermally conductive members in the pocket is disposed around a foam member 210. The foam member 210 may be elongated and semi-rigid and operable for use in exercise therapy. The substrate 212 may be secured about the foam member 210 with a fastener 214 such as zippers, VELCRO and the like. Some embodiments may use self-adhering devices such as those described in U.S. Pat. No. 7,950,114 which may provide an easier-to-use and more comfortable therapeutic experience.

In operation the thermally conductive members may be placed into either a microwave oven for heating effect or a freezer/refrigerator for cooling, then inserted into the pockets on the substrate such that the thermally conductive member is wrapped around the circumference of the foam member and held secure with the fastener. A user may then lie on the foam roller, using it to roll out tight and sore muscle groups, with the added benefit of the radiant heat or cooling permeating their muscles for greater therapeutic benefit. Alternatively, the thermally conductive members may be placed into the pockets before heating or cooling.

One having skill in the art will appreciate that the substrate may be constructed by cutting and sewing fabric together using the fabric thread, and sewing the fasteners, such as VELCRO, zippers and the like onto the fabric. The thermal conducting material may be sourced commercially.

In other embodiment the thermally conductive material may be inserted directly into the core of the foam member which would deliver the heating and cooling.

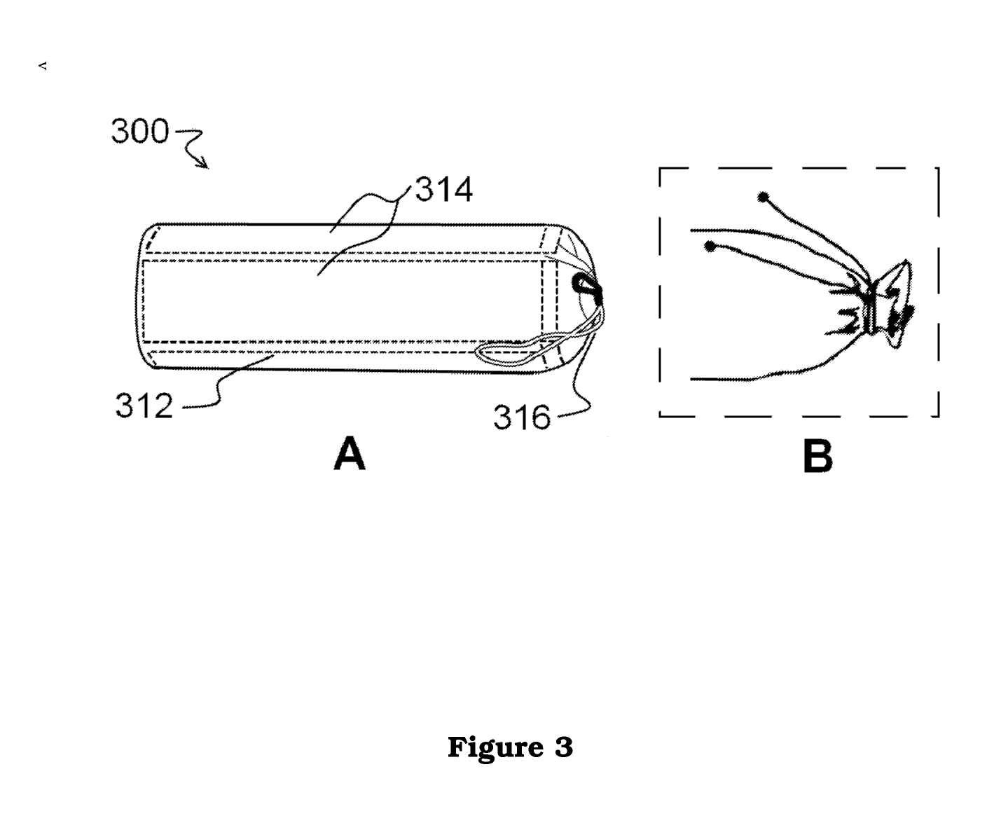

FIG. 3 shows an alternative embodiment according to the current disclosure. In FIG. 3A a pocketed substrate 312 having thermally conductive members in the pockets 314 is disposed around a foam member (not shown). The substrate 312 may be formed as a bag or “stuff sack” to facilitate placing it over an elongated foam member. The substrate 312 may include multiple pockets which may, in certain embodiments, overlap. The foam member may be elongated and semi-rigid and operable for use in exercise therapy. The substrate 312 may be secured about the foam member with a pull-tie fastener 316. The pull-tie fastener may be looped through a collar in an edge of the substrate. Some embodiments may employ a carrying strap disposed near the pull-tie or disposed on the surface of the substrate 312.

FIG. 3B shows and alternative means of securing the substrate 312 around a foam member through the use of a tie string which may, in certain embodiments, be secured to the substrate 312. A carry handle may also be affixed to the opening of the substrate.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A device including:
a fabric substrate including a plurality of enclosures;
a plurality of gel-based thermally conductive compounds, said compounds enclosed in a flexible, thermally-permeable material and disposed in each enclosure;
a substantially tubular foam member,
wherein the fabric substrate is a single material formed as a bag for enclosing the foam member, said bag having an opening at a first end, said opening including a draw-string closure.

2. The device of claim 1 wherein the enclosures are pockets and the thermally conductive compounds are removable.

3. A device comprising:
a substrate including a plurality of enclosures;
a plurality of thermally conductive compounds, said compounds enclosed in a flexible, thermally-permeable material and disposed in each enclosure;
a substantially tubular foam member,
wherein the substrate is a wrapped about the foam member such that the conductive compounds are disposed around the foam member.

4. The device of claim 3 wherein the substrate is thermally permeable.

5. The device of claim 3 wherein the thermally conductive compounds comprise either clay or corn.

6. The device of claim 3 wherein the thermally conductive compounds comprise a pliable, moisture sorbing gel including a humectant.

7. The device of claim 3 wherein the thermally conductive compounds are removable from the substrate.

8. The device of claim 3 further including a fastener operable to cinch the substrate to the foam member.

9. The device of claim 8 wherein the fastener is self-adhering.
